(19) United States
(12) Patent Application Publication
(10) Pub. No.: US 2004/0267633 A1
(43) Pub. Date: Dec. 30, 2004

(54) Layout system with order-placement capability, layout program with order-placement capability, and layout method

(75) Inventors: Toshio Tanaka, Shiojiri-shi (JP); Satoshi Yamada, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/804,056

(22) Filed: Mar. 19, 2004

(30) Foreign Application Priority Data
Mar. 24, 2003 (JP) 2003-081224
Jan. 20, 2004 (JP) 2004-011853

(51) Int. Cl. G06F 17/60

(52) U.S. Cl. 705/26

(57) ABSTRACT

There is provided a layout system with order-placement capability that is suitable for improving the efficiency of a process from designing a layout to placing an order for layout. The layout system 100 includes layout section 110 for performing layout according to user operations and layout order placing section 140 for placing an order for layout, depending on a layout result provided by the layout section 110.

### BACKGROUND OF THE INVENTION

1. Field of the Invention

The present invention relates to a system, program, and method for performing layout and placing an order for layout and, in particular, to a layout system with order-placement capability, a layout program with order-placement capability, and a layout method that are suited for improving the efficiency of a process from designing a layout to placing an order for layout.

2. Description of the Related Art

When a user places an order with a designer for layout, he or she creates a draft layout using a layout application program, for example, stores the draft layout in a storage medium such as a FD as electronic data, and sends the storage medium to the designer by mail along with a predetermined order form. Technologies for placing an order for layout services are disclosed in Japanese Patent Laid-Open No. 2002-140585, No. 2002-150056, and No. 2002-175447, for example. Technologies for performing layout are disclosed in Japanese Patent Laid-Open No. 10-16446, No. 11-91189, No. 2002-24633, No. 2002-183478, and No. 2002-222325, for example.

However, these inventions disclosed in the patent documents have a problem in that they cannot adequately improve efficiency because, although they allow the job of designing a layout and the job of placing an order for layout to be performed separately, they do not enable a process from designing a layout to placing an order for layout to be performed as one continuous operation.

The present invention has been made in view of the unsolved problem with such conventional technologies and an object of the present invention is to provide a layout system with order-placement capability, a layout program with order-placement-capability, and a lay out method that are suited for improving the efficiency of a process from designing a layout to placing an order for layout.

### SUMMARY OF THE INVENTION

(First Configuration)

In order to solve the above-described problem, a first configuration of the present invention provides a layout system with order-placement capability for performing layout, comprising: layout section for performing layout; and layout order placing section for placing an order for layout on the basis of a layout result produced by the layout section.

In this configuration, if placement of an order for layout is requested after layout is performed by the layout section, the layout order placing section places the order according to the layout result produced by the layout section.

This configuration allows a user to design a layout by using the layout section and also place an order for layout by using the layout order placing section. Thus, a process from designing a layout to placing an order for layout can be performed as one continuous operation. Consequently, the present system can improve the efficiency of the layout, compared with existing technologies.

The term “layout” as used herein refers to a display layout if layout is performed with the intention of displaying it on a screen, or a print layout if layout is performed with the intention of printing it on paper. The same applies to a layout program with order-placement capability and a layout method which will be described below.

The present system may be implemented as a single device, terminal or other apparatus, or maybe implemented as a network system consisting of a plurality of devices, terminals, or, other apparatuses communicably interconnected. In the latter case, each component of the present system may belong to any of the plurality of apparatuses.

(Second Configuration)

A second configuration of the present invention provides the layout system with order-placement capability according to the first configuration, further comprising user operation input section for inputting user operations, wherein the layout section performs layout according to operations inputted through the user operation input section.

In this configuration, when a user operation is inputted to the user operation input section the layout section performs layout according to the inputted operation.

(Third Configuration)

A third configuration of the present invention provides the layout system with order-placement capability according to the second configuration, wherein: the layout order placing section generates order data including a layout result produced by the layout section and sends the generated order data to a vendor together with an order request.

In this configuration, order data including a layout result produced by the layout section is generated by the layout order placing section and the generated order data is sent to a vender together with an order request. Thus, it can be ensured that an order request is provided to a vendor, such as a designer, together with order data.

The term “order request” as used herein consists of “order data” and “order directions” as shown in FIG. 12 and the “order data” consists of “layout data” and a “order condition.”

“Order directions” are directions including firm specifics such as a firm delivery date and price. “Order conditions” include a desired delivery date and price and descriptions of a quality level indicated by an intended use and an output method, and other requirements. “Layout data” is information about layout such as the type, content, position, capacity, font, and compression format of a content. The “order request” is represented by a structured document such as an XML document so that it can be interpreted by a human as well as a computer. The same applies to a layout system with order-placement capability, a layout program with order-placement capability, and a layout method which will be described below.

(Fourth Configuration)

A fourth configuration of the present invention provides the layout system with order-placement capability according to the second or third configuration, wherein the layout order placing section generates order data including an operation log information from which operations inputted through the user operation input section can be retraced and a layout result produced by the layout section and sends the generated data to a vendor together with an order request.

In this configuration, order data including an operation log information from which the log of the inputted operations can be retraced and a layout result produced by the layout section is generated by the layout order placing section and the generated order data is sent to a vender together with an order request.

Thus, the vendor can retrace the user operations from the operation log information and therefore can know the process in which the layout has been generated. Accordingly, the vendor can readily know the user's intent concerning the layout and therefore provide a layout that substantially satisfies the user's intent.

(Fifth Configuration)

A fifth configuration of the present invention provides the layout system with order-placement capability according to the second or third configuration, wherein: the layout order placing section generates order data including an operation log information indicating the log of operations inputted through the user operation input section and sends the generated order data to a vendor together with an order request.

Thus, as with the fourth configuration, the vendor can readily know the user's intent about the layout and therefore advantageously provide a layout that substantially satisfies the user's intent.

The operation log information of the present invention is not limited to a retracing of the log of operations inputted through the user operation input section as in the fourth configuration. The concept of the operation log is a broader concept including just statistic information indicating the priorities of contents to be laid out.

(Sixth Configuration)

A sixth configuration of the present invention provides the layout system with order-placement capability according to any of the first to fifth configurations, wherein the layout system is communicably connected to a matching system that performs matching with a designer, and the layout order placing section generates order data including a layout result produced by the layout section and sends the generated order data to the matching system together with an order request.

In this configuration, order data including a layout result produced by the layout section is generated by the layout order placing section and the generated order data is sent to the matching system together with an order request.

When receiving the order data, the matching system performs matching with designers on the basis of the received order data.

Thus, a layout that substantially satisfies the user's intent can advantageously be provided.

The term “matching” as used herein means finding a suitable vender or designer. The same applies to a layout system with order-placement capability, a layout program with order-placement capability, and a layout method which will be described below.

(Seventh Configuration)

A seventh configuration of the present invention provides the layout system with order-placement capability according to any of the first to fifth configurations, wherein the layout system is communicably connected to a matching system for matching an order request with a designer, and the layout order placing section generates order data including a layout result produced by the layout section and sends the generated order data to the matching system together with an order request.

As with the sixth configuration, when receiving order data, the matching system performs matching with a designer on the basis of the order data. Consequently, a layout that substantially satisfies the user's intent can advantageously be provided.

(Eighth Configuration)

An eighth configuration of the present invention provides the layout system with order-placement capability according to the first to seventh configurations, further comprising layout evaluating section for evaluating a layout result produced by the layout section.

In this configuration, a layout result produced by the layout section is evaluated by the layout evaluating section.

This allows a user to perform layout tasks with reference to the evaluation result. Consequently, a higher quality layout can advantageously be provided.

(Ninth Configuration)

A ninth configuration of the present invention provides the layout system with order-placement capability according to the eighth configuration, wherein: the layout evaluating section evaluates a layout result produced by the layout section and, depending on the result of the evaluation, requests the layout order placing section to place an order for layout; and the layout order placing section places an order for layout on the basis of a layout result produced by the layout section if the layout order placing section is requested to place an order for layout.

In this configuration, a layout result produced by the layout section is evaluated by the layout evaluating section and a request for placing an order for layout is provided to the layout order placing section depending on the result of the evaluation. When receiving the request, the layout order placing section places the layout order according to the layout result produced by the layout section.

Thus, an order for layout is placed on the basis of the result of the evaluation and therefore a higher quality layout result can advantageously be provided to a vendor.

(Tenth Configuration)

A tenth configuration of the present invention provides the layout system with order-placement capability according to the eighth or ninth configuration, wherein an order condition can be set in the layout system, and the layout evaluating section evaluates a layout result produced by the layout section and, if the result of the evaluation meets the order condition, requests the layout order placing section to place an order for layout.

In this configuration, a layout result produced by the layout section is evaluated by the layout evaluating section and, if the evaluation result meets an order condition, the layout order placement section is requested to place an order for layout.

Thus, because an order condition can be set by a user, a layout result of a quality according to the order condition can be provided to a vendor.

(Eleventh Configuration)

An eleventh configuration of the present invention provides the layout system with order-placement capability according to any of the eighth to tenth configurations, wherein the layout evaluating section presents the evaluation result to a user and, if placement of an order for layout is approved by the user, requests the layout order placing section to place the order for layout.

In this configuration, the result of evaluation is presented to the user by the layout evaluating section. The user sees the presented evaluation result and gives approval to placement of an order on the basis of the evaluation result. If approved, the layout evaluating section request the layout order placing section to place the order for layout.

In this way, the user can see an evaluation result before an order for layout is placed. Consequently the possibility that an order that is not desired by the user is placed can advantageously be reduced.

(Twelfth Configuration)

A twelfth configuration of the present invention provides the layout system with order-placement capability according to any of the first to eleventh configurations, wherein: the layout order placing section places an order for layout on the basis of a layout result produced by the layout section by using one of a plurality of ordering scheme that is specified by the user.

In this configuration, one of a plurality of ordering scheme that is specified by the user is used to place an order for layout on the basis of a layout result produced by the layout section.

This can improve the usability of the system because an order for layout can be placed by using a user-specified ordering scheme.

(Thirteenth Configuration)

In another aspect, to achieve the objective described earlier, a thirteenth configuration of the present invention provides a layout program with order-placement capability for performing layout that causes a computer to perform processing implemented as layout section for performing layout and layout order placing section for placing an order for layout depending on a layout result produced by the layout section.

In this configuration, effects and advantages equivalent to those of the layout system with order-placement capability of the first configuration can be provided by the computer reading the program and executing the processing.

(Fourteenth Configuration)

A fourteenth configuration of the present invention provides the layout program with order-placement capability according to the thirteenth configuration, further comprising user operation input section for inputting user operations, wherein the layout section performs layout according to operations inputted through the user operation input section.

In this configuration, when a user operation is inputted to the user operation input section the layout section performs layout according to the inputted operation, as with the second configuration.

(Fifteenth Configuration)

A fifteenth configuration of the present invention provides the layout program with order-placement capability according to the fourteenth configuration, wherein: the layout order placing section generates order data including a layout result produced by the layout section and sends the generated order data to a vendor together with an order request.

Thus, it can be ensured that an order request is provided to a vendor such as a designer together with order data, as with the third configuration.

(Sixteenth Configuration)

A sixteenth configuration of the present invention provides the layout program with order-placement capability according to the fourteenth or fifteenth configuration, wherein the layout order placing section generates order data including an operation log from which operations inputted through the user operation input section can be retraced and a layout result produced by the layout section and sends the generated order data to a vendor together with an order request.

Thus, as with the fourth configuration, the vendor can readily know the user's intent about the layout and therefore advantageously provide a layout that substantially satisfies the user's intent.

(Seventeenth Configuration)

A seventeenth configuration of the present invention provides the layout program with order-placement capability according to the fourteenth or fifteenth configuration, wherein the layout order placing section generates order data including an operation log indicating the log of operations inputted through the user operation input section and a layout result produced by the layout section and sends the generated order data to a vendor together with an order request.

Thus, as with the sixteenth configuration, the vendor can readily know the user's intent about the layout and therefore advantageously provide a layout that substantially satisfies the user's intent.

(Eighteenth Configuration)

An eighteenth configuration of the present invention provides the layout program with order-placement capability according to any of the thirteenth to seventeenth configurations, wherein the layout program communicably connects to a matching system that performs matching with a designer, and the layout order placing section generates order data including a layout result produced by the layout section and sends the generated order data to the matching system together with an order request.

Thus, as with the sixth configuration, a layout that substantially satisfies the user's intent can advantageously be provided.

(Nineteenth Configuration)

A nineteenth configuration of the present invention provides the layout program with order-placement capability according to any of the first to seventeenth configurations, wherein the layout system is communicably connected to a matching system for matching an order request with a designer, and the layout order placing section generates order data including a layout result produced by the layout section and sends the generated order data to the matching system together with an order request.

As with the seventh configuration, when receiving order data, the matching system performs matching with a designer on the basis of the order data. Consequently, a layout that substantially satisfies the user's intent can advantageously be provided.

(Twentieth Configuration)

A twentieth configuration of the present invention provides the layout program with order-placement capability according to any of the first to nineteenth configurations, further comprising layout evaluating section for evaluating a layout result produced by the layout section.

This allows a user to perform layout tasks with reference to the evaluation result, as with the eighth configuration. Consequently, a higher quality layout can advantageously be provided.

(Twenty-First Configuration)

A twenty-first configuration of the present invention provides the layout program with order-placement capability according to the twentieth configuration, wherein: the layout evaluating section evaluates a layout result produced by the layout section and, depending on the result of the evaluation, requests the layout order placing section to place an order for layout; and the layout order placing section places an order for layout on the basis of a layout result produced by the layout section if the layout order placing section is requested to place an order for layout.

Thus, an order for layout is placed on the basis of the result of the evaluation and therefore a higher quality layout result can advantageously be provided to a vendor.

(Twenty-Second Configuration)

A twenty-second configuration of the present invention provides the layout program with order-placement capability according to the twentieth or twenty-first configuration, wherein an order condition can be set and the layout evaluating section evaluates a layout result produced by the layout section and, if the result of the evaluation meets the order condition, requests the layout order placing section to place an order for layout.

Thus, because an order condition can be set by a user, as with the ninth configuration, a layout result of a quality according to the order condition can be provided to a vendor.

(Twenty-Third Configuration)

A twenty-third configuration of the present invention provides the layout program with order-placement capability according to any of the twentieth to twenty-second configurations, wherein the layout evaluating section presents the evaluation result to a user and, if placement of an order for layout is approved by the user, requests the layout order placing section to place the order for layout.

Thus, as with the eleventh configuration, the user can see an evaluation result before an order for layout is placed. Consequently the possibility that an order that is not desired by the user is placed can advantageously be reduced.

(Twenty-Fourth Configuration)

A twenty-fourth configuration of the present invention provides the layout program with order-placement capability according to any of the thirteenth to twenty-third configurations, wherein: the layout order placing section places an order for layout on the basis of a layout result produced by the layout section by using one of a plurality of ordering system that is specified by the user.

Thus, the usability of the system can be improved because an order for layout can be placed by using a user-specified ordering scheme, as with the twelfth configuration.

(Twenty-Fifth Configuration)

In another aspect, to achieve the objective described earlier, a twenty-fifth configuration of the present invention provides a layout method with order-placement capability for performing layout, comprising: a layout step of performing layout and a layout order placing step of placing an order for layout depending on a layout result produced in the layout step.

This configuration provides advantages equivalent to those of the layout system with order-placement capability of the first configuration.

(Twenty-Sixth Configuration)

A twenty-sixth configuration of the present invention provides the layout method according to the twenty-fifth configuration, wherein the layout step performs layout according to operations inputted by a user.

In this configuration, layout is performed according to inputted user operations, as with the second configuration.

(Twenty-Seventh Configuration)

A twenty-seventh configuration of the present invention provides the layout method with order-placement capability according to twenty-sixth configuration, wherein said layout step generates order data including a layout result and sends the generated order data to a vendor together with an order request.

Thus, as with the third configuration, it can be ensured that an order request is provided to a vendor, such as a designer, together with order data.

(Twenty-Eighth Configuration)

A twenty-eighth configuration of the present invention provides the layout method with order-placement capability according to the twenty-sixth or twenty-seventh configuration, wherein said layout order placing step generates order data including an operation log from which operations inputted by the user can be retraced and a layout result produced in the layout step and sends the generated order data to a vendor together with an order request.

Thus, as with the fourth configuration, the vendor can readily know the user's intent about the layout and therefore advantageously provide a layout that substantially satisfies the user's intent.

(Twenty-Ninth Configuration)

A twenty-ninth configuration of the present invention provides the layout method with order-placement capability according to the twenty-sixth or twenty-seventh configuration, wherein: the layout order placing step generates order data including an operation log indicating the log of operations inputted by the user and a layout result produced in the layout step and sends the generated order data to a vendor together with an order request.

Thus, as with the sixteenth configuration, the vendor can readily know the user's intent about the layout and therefore advantageously provide a layout that substantially satisfies the user's intent.

(Thirtieth Configuration)

A thirtieth configuration of the present invention provides the layout method with order-placement capability according to any of the twenty-fifth to twenty-ninth configurations, further comprising the step of communicably connecting to a matching system that performs matching with a designer, wherein the layout order placing step generates order data including a layout result produced in the layout step and sends the generated order data to the matching system together with an order request.

Thus, as with the sixth configuration, a layout that substantially satisfies the user's intent can advantageously be provided.

(Thirty-First Configuration)

A thirty-first configuration of the present invention provides the layout method with order-placement capability according to any of the twenty-fifth to twenty-ninth configurations, further comprising the step of communicably connecting to a matching system for matching an order request with a designer, wherein the layout order placing step generates order data including a layout result produced in the layout step and sends the generated order data to the matching system together with an order request.

As with the seventh configuration, when receiving order data, the matching system performs matching with a designer on the basis of the order data. Consequently, a layout that substantially satisfies the user's intent can advantageously be provided.

(Thirty-Second Configuration)

A thirty-second configuration of the present invention provides the layout method with order-placement capability according to any of the thirteenth to thirty-first configurations, further comprising a layout evaluating step of evaluating a layout result produced in the layout step.

This allows a user to perform layout tasks with reference to the evaluation result, as with the eighth configuration. Consequently, a higher quality layout can advantageously be provided.

(Thirty-Third Configuration)

A thirty-third configuration of the present invention provides the layout method with order-placement capability according to the thirty-second configuration, wherein the layout evaluating step evaluates a layout result produced in the layout step and, depending on the result of the evaluation, requests the layout order placing step to place an order for layout; and the layout placing step places an order for layout on the basis of a layout result produced in the layout step if the layout order placing step is requested to place an order for layout.

Thus, an order for layout is placed on the basis of the result of the evaluation and therefore a higher quality layout result can advantageously be provided to a vendor.

(Thirty-Fourth Configuration)

A thirty-fourth configuration of the present invention provides the layout method with order-placement capability according to the thirty-second or thirty-third configuration, wherein an order condition can be set in the layout system, the layout evaluating step evaluates a layout result produced in the layout step and, if the result of the evaluation meets the order condition, requests the layout order placing step to place an order for layout.

Thus, because an order condition can be set by a user, as with the ninth configuration, a layout result of a quality according to the order condition can be provided to a vendor.

(Thirty-Fifth Configuration)

A thirty-fifth configuration of the present invention provides the layout method with order-placement capability according to any of the thirty-second to thirty-fourth configurations, wherein the layout evaluating step presents the evaluation result to a user and, if placement of an order for layout is approved by the user, requests the layout order placing step to place the order for layout.

Thus, as with the eleventh configuration, the user can see an evaluation result before an order for layout is placed. Consequently the possibility that an order that is not desired by the user is placed can advantageously be reduced.

(Thirty-Sixth Configuration)

A thirty-sixth configuration of the present invention provides the layout method with order-placement capability according to any of the twenty-fifth to thirty-fifth configurations, wherein the layout order placing step places an order for layout on the basis of a layout result produced in the layout step by using one of a plurality of ordering system that is specified by the user.

Thus, the usability of the system can be improved because an order for layout can be placed by using a user-specified ordering scheme, as with the twelfth configuration.

### BRIEF DESCRIPTION OF THE DRAWINGS

FIG. 1 is a block diagram showing a configuration of a layout apparatus 100 according to a first embodiment of the present invention;

FIG. 2 shows a layout and operation screen;

FIG. 3 shows an example in which user operations are on the basis of layout data;

FIG. 4 shows an example in which the priorities of content containing frames are calculated on the basis of layout data;

FIG. 5 is a block diagram showing an configuration of a layout system according to a second embodiment of the present invention;

FIG. 6 shows a data structure of data in an order condition registration unit;

FIG. 7 is a flowchart of a layout evaluating process;

FIG. 8 is a block diagram showing a configuration of a layout system according to a third embodiment of the present invention;

FIG. 9 is a block diagram showing a configuration of a layout system according to a fourth embodiment of the present invention;

FIG. 10 shows a data structure of data in an order condition registration unit;

FIG. 11 is a flowchart of a layout finishing process; and

FIG. 12 shows a structure of an order request.

### DETAILED DESCRIPTION OF THE PREFERRED EMBODIMENTS

A first embodiment of the present invention will be described with reference to the drawings.

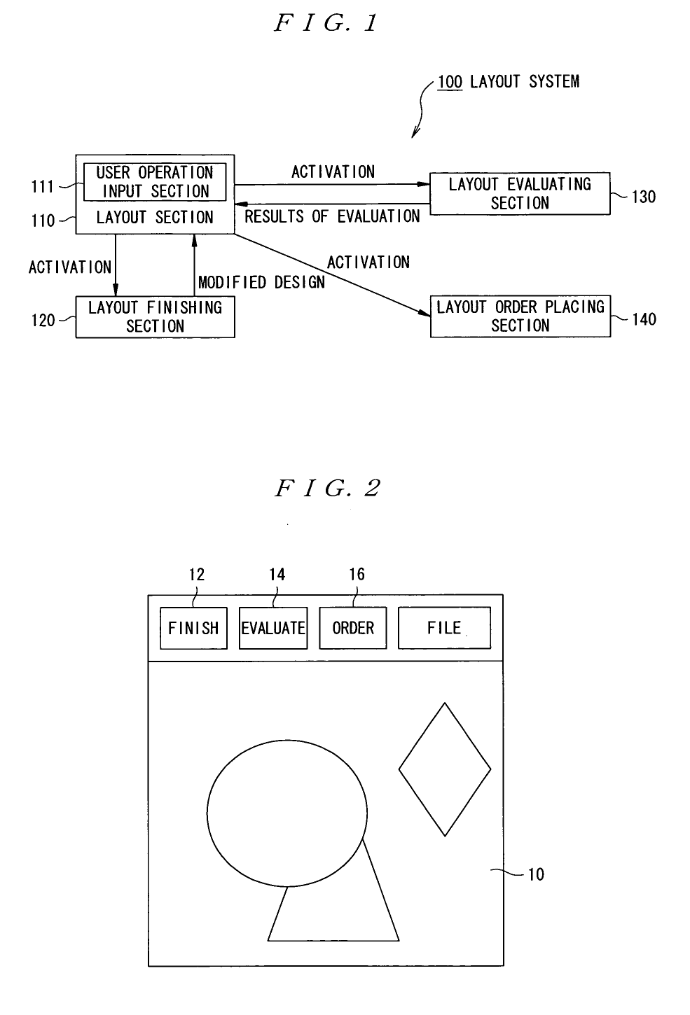

FIGS. 1 to 4 shows a layout system with order-placement capability and layout program with order-placement capability and a layout method according to the first embodiment of the present invention.

In the first embodiment, a layout system with order-placement capability and a layout program with order-placement capability, and a layout method according to the present invention are applied to a case where a layout is designed and then an order for layout is placed as shown in FIG. 1.

A configuration of the layout system according to the present embodiment will be described first with reference to FIG. 1.

FIG. 1 is a block diagram showing a configuration of the layout system 100 according to the first embodiment.

The layout system 100 comprises layout section 110 for performing layout, layout finishing section 120 for make finishing adjustments to a layout based on the layout result produced in the layout section 110, layout evaluating section 130 for evaluating the layout result provided in the layout section 110, and layout order placing section 140 for placing an order for layout based on the layout result produced in the layout section 110.

The layout section 110 includes user operation input section 111 such as a keyboard and a mouse and performs layout by placing content containing frames for containing contents in a predetermined layout area according to operations performed by a user through the user operation input section 111.

If an operation for generating a content containing frame is inputted, the content containing frame of a predetermined size is generated in a predetermined position in the layout area.

If an operation for manipulating an attribute of a content containing frame (a parameter specifying the position, size, or shape of a content containing frame or a font or color used in the frame) is inputted, the specified attribute of a content containing frame is changed according to the operation.

If an operation for placing a content in a content containing frame is inputted, the specified content is read from a content storage database (herein after a database is abbreviated to DB) (not shown) and placed in the specified content containing frame.

In addition, the layout section 110 performs layout and generates operation log information concerning operations performed by a user and stores it in an operation log information storage DB (not shown).

FIG. 2 shows a layout and operation screen.

When a button icon 12 on which text “Finish” is displayed as shown in FIG. 2 is clicked to request activation of the layout finishing section 120, the layout section 110 provides a layout result 10 to the layout finishing section 120 along with an activation request.

When a button icon 14 labeled “Evaluate” is clicked to request activation of the layout evaluating section 130, the layout result 10 is provided to the layout evaluating section 130 along with an activation request. When a button icon 16 labeled “Order” is clicked to request activation of the layout order placing section 140, the layout result 10 is provided to the layout order placing section 140 along with an activation request.

The layout finishing section 120 is activated in response to an activation request from the layout section 110 and makes finishing adjustments to a layout result generated by the layout section 110 by adjusting the layout, color, and text representation and also making adjustments to an image, photograph or illustration.

Layout adjustments include, for example, space adjustments, an adjustment to the size of a content containing frame, the size of font in a content containing frame, and the size of an image. Color adjustments are made by adjusting color harmony in an entire page or modifying a background color if the background color is similar to a foreground color, for example. Adjustments to text representation may include making writing style and notation consistent, changing informal expressions into formal ones, and rephrasing repeated expressions.

Adjustments to an image, photograph, or illustration may includes adjustments to the size and color tone.

The layout evaluating section 130 is activated in response to an activation request from the layout section 110. The layout evaluating section 130 evaluates a given item of a layout result generated by the layout section 110 and displays evaluation results on an output unit such as a display to present it to a user.

Items to be evaluated may include: (1) the disposition, amount, or balance of spaces, (2) the size of a content containing frame, (3) the layout of text and images in a content containing frame, (4) the color tone of the entire page, (5) background and foreground colors, (6) the writing style of text, (7) the consistency of notation, (8) repeated expressions in text, (9) the size of an image, photograph, or illustration, and (10) the color tone of an image, photograph, or illustration.

The layout order placing section 140 is activated in response to an activation request from the layout section 110, generates layout data including a layout result generated by the layout section 110 and operation log information in the operation log information storage DB concerning operations performed through the user operation input section 111, and sends the layout data along with an order request to a vendor (designer).

An order to be placed with a vendor (designer) may be provided to a matching system that find a designer suitable for the order request. Alternatively, a designer may be explicitly specified.

An important point in the present invention is to send layout data on layouts that have been made by a user up to that time to a designer when placing an order for layout.

The layout data includes operation log information and the designer can retrace the user's operation log on an output unit such as a display. The operation log can be retraced continuously like a movie or retraced step by step on an operation-by-operation basis. In addition, information about which content the user gave weight to can be extracted from the layout data and presented as layout setting information.

Thus, the designer that received the order can see the user's operation log and obtain information about what the user cares about. In addition, layout priorities can be calculated from the operation log information and provided to the designer. This allows the designer to know what the user cares about, without having to retrace the user's operation log. Furthermore, a layout result and operation log information are sent to the user when an order is placed, which aids a designer in making decision whether to accept the order or not and also allows the user to find the designer most suitable for an order request reliably. For example, if a user cares about a photograph, a designer who is good at photographs can receive an order or the user can place an order with a designer who is good at photographs.

A matching system for matching an order request with a vendor such as a designer may be the one disclosed in Japanese Patent Laid-Open No. 2002-150033, for example.

Operations of the present embodiment will be described below.

A user can use the layout section 110 to perform layout tasks. When performing layout, the user inputs operations through the user operation input section 111. When operations are inputted, the layout section 110 performs layout according to the inputted user operations and generates operation log information. The operation log information is stored in the operation log information storage DB.

The user also can use the layout finishing section 120 to make finishing adjustments to the layout. Before performing finishing adjustments, the user issues at the layout system 100 a request for activation of the layout finishing section 120.

When activation of the layout finishing section 120 is requested, the layout section 110 provides a layout result to the layout finishing section 120 along with the activation request.

When the layout finishing section 120 is activated in response to the activation request, the layout finishing section 120 makes adjustments to the layout result provided by the layout section 110, such as layout adjustments, text expression adjustments, and image, photograph, or illustration adjustments.

The user can use the layout evaluating section 130 to obtain an evaluation of the layout. To obtain an evaluation of the layout, the user requests for activation of the layout evaluating section 130.

When activation of the layout evaluating section 130 is requested, the layout section 110 provides the layout result to the layout evaluating section 130 along with the activation request.

When the layout evaluating section 130 is activated in response to the activation request, the layout evaluating section 130 evaluates given items of the layout result provided by the layout section 110 and presents the results of the evaluation to the user.

The user can use the layout order placing section 140 to pace an order for layout. To place the layout order, the user requests for activation of the layout order placing section 140.

When activation of the layout order placing section 140 is requested, the layout section 110 provides the layout result to the layout order placing section 140 along with the activation request.

When the layout order placing section 140 is activated in response to the activation request, the layout order placing section 140 generates layout data including the layout result produced by the layout section 110 and operation log information in the operation log information storage DB and sends the layout data to a vendor along with an order request.

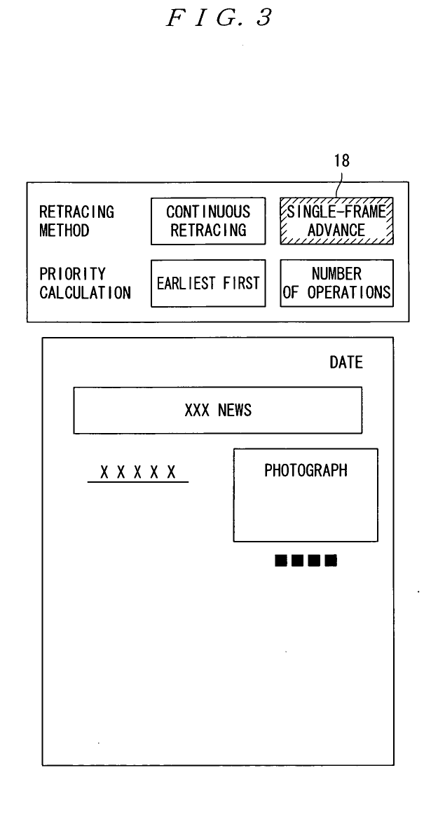

FIG. 3 shows an example in which user operations are retraced based on the layout data.

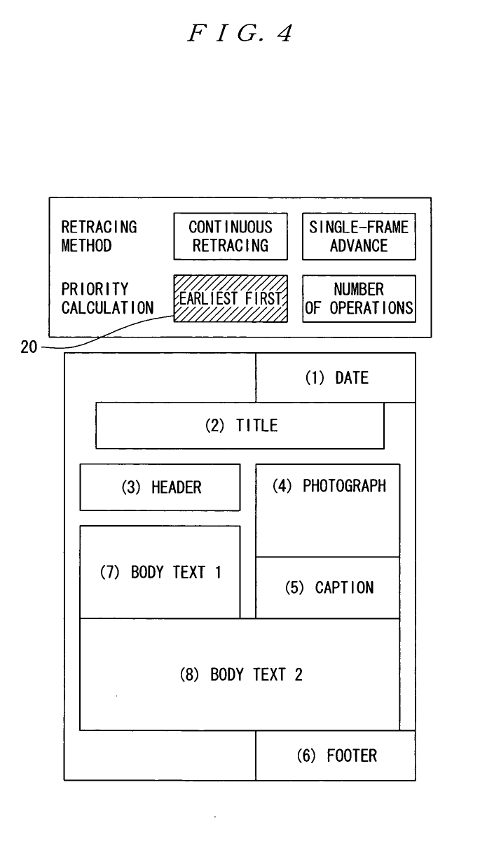

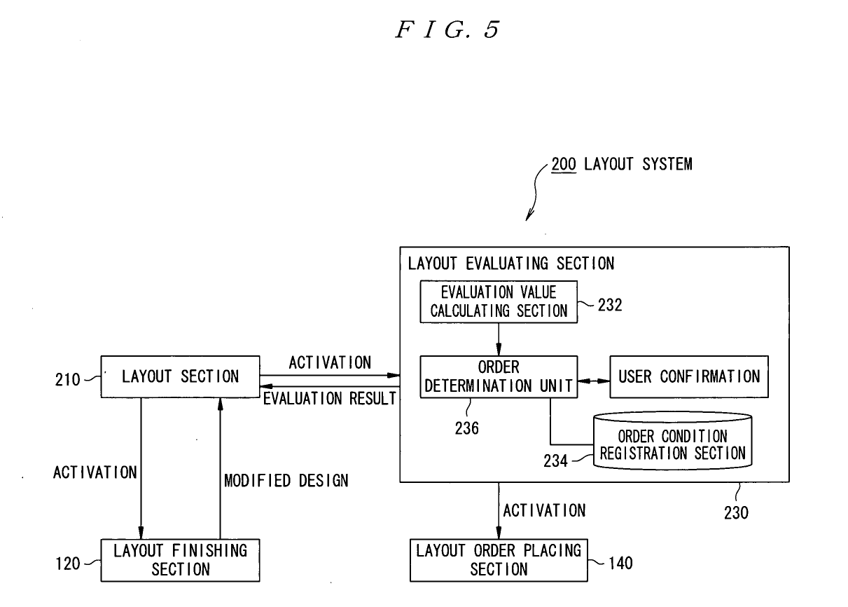

FIG. 4 shows an example in which the priorities of content containing frames are calculated from the layout data.

When the layout data is received at a vendor (designer) along with an order request, the vendor can retrace user operations from the layout data through the user of a given application and calculate the priorities of content containing frames.

To retrace user operations, the designer clicks a button icon 18 labeled “Single-frame advance” as shown in FIG. 3 to request retracing of operations.

When retracing of the operations are requested, a sequence of operations performed by the use during layout are retraced in chronological order on the basis of operation log information included in the received layout data at the vendor. In the example shown in FIG. 3, user operations are retraced step by step on a operation-by-operation basis.

One of the following methods may be used for retracing operation log information, depending on how operation log information is maintained.

A first method is to record operations performed to each content containing frame. According to this method, operations performed for each individual content can be retraced in chronological order and therefore the operation log can be seen on a content-by-content basis. A second method is to record operations of application software. According to this method, layout data can be more understandably retraced by retracing operations to the application software. A third method is to record mouse information. According to this method, the position of mouse at each time point can be retraced and therefore positions in a content or time in which the user wavered in judgment during layout can be indicated more specifically. A fourth method is to record screenshots. According to this method, relatively precise time information can be obtained by retracing, in chronological order, images that were displayed while the user was working on a layout, therefore intuitive information about where the user was wavering in judgment can be obtained.

When calculating the priorities of content containing frames, the user clicks a button icon 20 labeled “Earliest first,” for example, to request calculation of the priorities.

When the calculation of priorities are requested at the vendor, the priorities of content containing frames placed in a layout area are calculated on the basis of operation log information included in received layout data. In the example shown in FIG. 4, the order in which content containing frames disposed in a layout area were completed is calculated and the priorities of the frames are calculated. The highest priority is given to the content containing frame the editing of which was completed earliest. In this example, editing of the date, title, header, photograph, caption, footer, text 1, and text 2 was completed in that order. Therefore, priorities are given in that order.

According to the present embodiment, the layout system 100 comprises the layout section 110 for performing layout according to operations performed by a user and the layout order placing section 140 for placing an order for layout based on a layout result produced by the layout section 110, as described above.

Thus, the user can use the layout section 110 to make a layout and also can use the layout order placing section 140 to place an order for layout.

Therefore, the user can perform a process from designing a layout to placing an order for layout as one continuous operation. Consequently, the present embodiment can improve the efficiency of the layout compared with conventional technologies.

Furthermore, according to the present embodiment, the layout order placing section 140 generates layout data including the layout result produced by the layout section 110 and operation log information in the operation log information storage DB and sends the generated layout data to a vendor along with an order request.

The vendor can retrace user's operations based on the operation log information and therefore can know the process in which the layout was generated.

Accordingly, the designer can readily know the user's intent concerning the layout and provide a layout that substantially satisfies the user's intent.

Furthermore, according to the present embodiment, the layout order placing section 140 generates layout data including a layout result provided by the layout section 110 and sends the generated layout data to the matching system along with an order request.

Thus, a layout that substantially satisfies the user's intent can be implemented.

According to the present embodiment, the layout system 100 includes the layout evaluating section 130 for evaluating given items of a layout result generated by the layout section 110.

The user can perform layout tasks with reference to the results of the evaluation provided and therefore can produce a higher quality layout.

In the matching system for finding a designer suitable for a layout when an order request is issued, the designer best suited among the designers registered with the system is found on the basis of order conditions (the delivery date, desired price, descriptions of the quality level of the layout indicated by information such as an intended use and an layout output method, and other requirements) and layout data, and an order for layout is placed with the designer. An order request does not necessarily have to include order conditions in cases where an order is placed with a fixed vendor or order conditions are fixed.

An order request can be generated by a user inputting information on each item of a layout through the user operation input section 111. If an order is placed again, data including requirements previously set may be held and only information such as a delivery date and price that varies order from order is inputted. Furthermore, the delivery date may be calculated from the order date, the price may be determined from the number of layout pages, or these items of data may be obtained form another system such as a scheduling management system and a budget management system.

A layout result included in an order request may be original data that results from layout performed by a user and was stored as well as such data to which modifications are made.

For example, a content element such as text and an image may be extracted from stored data and separated from content containing frame data. The content element is checked to see whether its data format is proper or whether the corporate color or format of a logo conforms to a scheme. Modification may be made to layout elements so as to conform to a scheme. This ensures a high quality of the completed document. If a designer uses a layout application program different from one used by a user to perform layout tasks, content-containing frame data can be separated from the content containing frame data from its content elements and converted into a format usable with the designer's application program. Even if content containing frame data cannot be converted, at least its content elements can be made available by separating them from the containing data.

Moreover, the way an operation log information to be included in an order request is held is not limited to specific one. Examples of possible methods include: (1) chronologically recording which operations were performed for which content containing frame; (2) recording menu operations, menu selections, content containing frame operations, and window operations performed in application software used for designing; (3) recording mouse positions at predetermined intervals and recording events (clicks or entrance of a mouse pointer into certain regions) generated by the mouse; and (4) recording output images (previews) of a design at predetermined intervals. If one wants to obtain information about the priorities of contents, it is desirable that method (1) be used to record the operation log. Method (4) has an advantage that it can be accomplished by simple processing, though the retraceability of operations is low.

The operation log information to be included in an order request is not limited to a retracing of the log of operations inputted through the user operation input section 111. It may be just statistic information indicating the priorities of contents to be laid out, for example, as shown in FIG. 4.

A second embodiment of the present invention will be described below with reference to the drawings.

FIGS. 5 to 7 shows a layout system with order-placement capability, a layout program with order-placement capability, and a layout method according to a second embodiment of the present invention.

In the second embodiment, a layout system with order-placement capability and a layout program with order-placement capability, and a layout method according to the present invention are applied to a case where a layout is designed and then an order for the layout is placed. The second embodiment differs from the first embodiment in that layout evaluating section 230 activates layout order placing section 140, as shown in FIG. 5. In the following description, only different elements of the second embodiments from the first embodiment will be described. The same elements of the second embodiment as those in the first embodiment are labeled with the same reference numerals and therefore the description thereof will be omitted.

A configuration of a layout system 200 according to the present embodiment will be described with reference to FIG. 5.

FIG. 5 is a block diagram showing a configuration of the layout system 200 according to the second embodiment of the present invention.

As shown in FIG. 5, the layout system 200 comprises layout section 210 for performing layout, layout finishing section 120 for making finishing adjustments to a layout based on the layout result provided by the layout section 210, layout evaluating section 230 for evaluating the layout result provided by the layout section 210, and layout order placing section 140 for placing an order for layout according to the layout result provided by the layout section 210.

The layout section 210 has the same configuration as that of the layout section 110 described above with respect to the first embodiment, except that it does not directly activate the layout order placing section 140.

The layout evaluating section 230 includes an evaluation value calculating unit 232 for calculating the evaluation value of a layout result produced by the layout section 210, an order condition registration unit 234 in which order conditions are registered, and an order determination unit 236 for determining on the basis of an evaluation value calculated in the evaluation value calculating unit 232 and order conditions in the order condition registration unit 234 whether or not a layout should be placed or not, as shown in FIG. 5.

The evaluation value calculating unit 232 is activated in response to an activation request from the layout section 210, evaluates the given items of a layout result produced by the layout section 210, and calculates an evaluation value to provide an evaluation result.

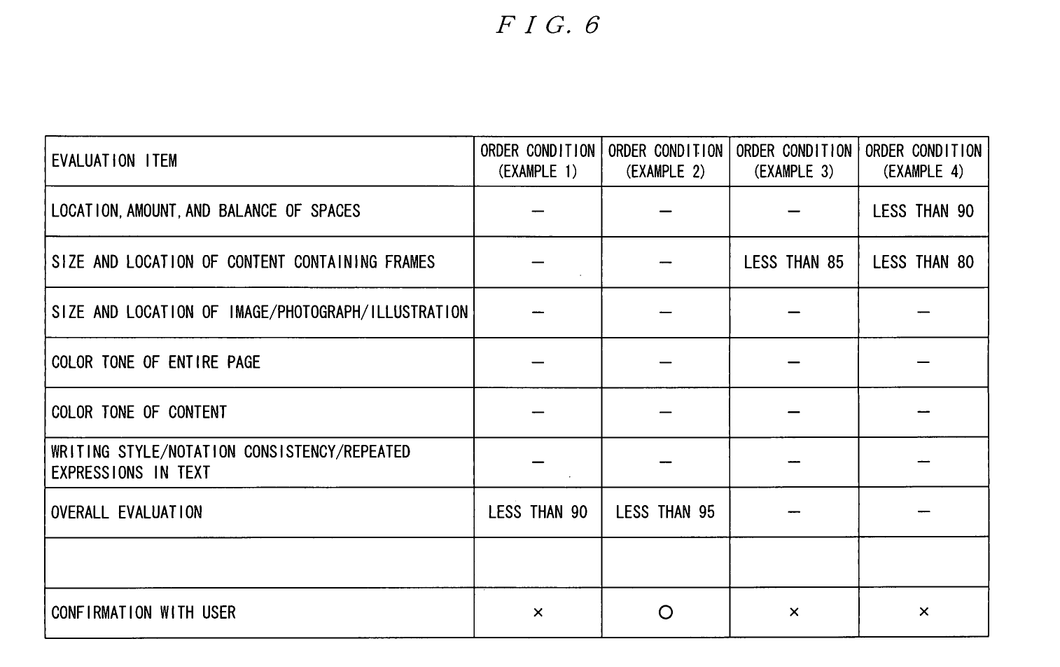

FIG. 6 shows a structure of data in the order condition registration unit 234.

As shown in FIG. 6, registered in the order condition registration unit 234 are registration conditions for determining whether or not an order for a layout should be placed.

An order condition can be set for each item of evaluation. In the example shown in FIG. 6, order condition 1 is that the overall evaluation value of a layout result is less than 90 and user confirmation is not required for placing an order for layout. Condition 2 is that the overall evaluation value of a layout result is lower than 95 and user confirmation is required for placing an order for layout. Condition 3 is that the evaluation value of the size and location of content containing frames is less than 85 and user confirmation is not required for placing an order for layout. Order condition 4 is that the evaluation value of the location, amount, or balance of spaces is lower than 90, the evaluation value of the size and location of content containing frames is less than 80, and user confirmation is not required for placing an order for layout.

Order conditions are set for a group. For example, if condition example 1 in FIG. 6 is set as an order condition for a group and the overall evaluation of a layout is less than 90, the layout is outsourced. Consequently, it can be ensured that a layout that has an overall evaluation of 90 or higher is ultimately provided. If a layout produced by a user by him/herself has obtained a required overall evaluation, an unnecessary order for layout can be prevented.

Furthermore, because a condition can be set for each evaluation item, design level consistency can advantageously be ensured. For example, in condition example 4 in FIG. 6, the highest priority is placed on the locations, amount, or balance of spaces, the second highest priority is placed on the sizes and locations of content containing frames, and lower priorities are placed on the color tone and the writing style of text. The condition is that the location of spaces must come first to provide consistency and colors and text may be unmodified. In contrast, if conditions are set on the color tone of the overall page or contents, consistency of color tone can be achieved.

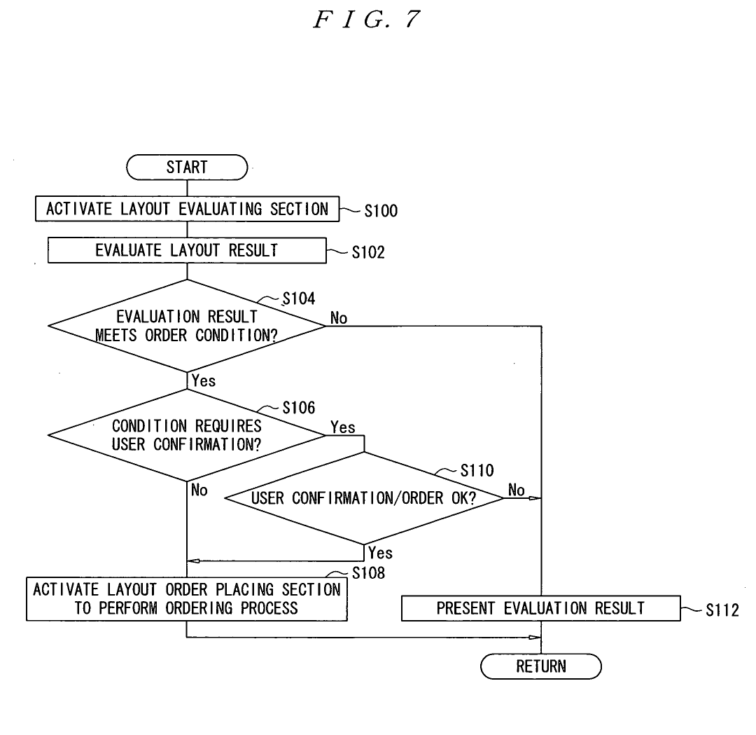

In practice, the layout evaluating section 230 has the same capabilities as those of a typical computer and includes a CPU, ROM, RAM, interface, and other components interconnected through a bus. The CPU activate a given program stored in a predetermined area in the ROM and performs a layout evaluating process shown in a flowchart in FIG. 7 according to the program.

FIG. 7 is a flowchart of the layout evaluating process.

When the layout evaluating process is initiated in the CPU, the process proceeds to step S100 as shown in FIG. 7.

At step S100, the layout evaluating section 230 is activated and the process proceeds to step S102, where given evaluation items of a layout result produced by the layout section 210 is evaluated, then the process proceeds to step S104. In particular, the following items are evaluated at step S102: (1) the location, amount, or balance of spaces; (2) the size or location of content containing frames; (3) the size or location of an image, photograph, or illustration in a content containing frame; (4) the color tone of an entire page; (5) the color tone of a content containing frame; and (6) the consistency of writing style and notation and repetition of the same expressions in text are evaluated based on a scale of 100. Alternatively, the weighted average of these items may be calculated and normalized for a maximum of 100 to obtain an overall evaluation.

At step S104, the evaluation result is compared with any of order conditions to determine whether or not it meets that order condition. If it is determined that the evaluation result meets the order condition (Yes), the process proceeds to step S106, where determination is made as to whether or not the condition specifies that user confirmation is required. If it is determined that user confirmation is not required by the condition (No), the process proceeds to step S108.

At step S108, the layout result provided by the layout section 210 is outputted to the layout order placing section 140 along with an activation request, and then the process will end and return control to the previous process.

On the other hand, if it is determined at step S106 that the order condition requires user confirmation (Yes), the process proceeds to step S110, where the user is prompted to confirm the order and determination is made as to whether or not confirmation has been provided by the user. If it is determined that confirmation has been provided by the user (Yes), the process proceeds to step S108.

On the other hand, if it is determined at step S110 that confirmation has not been provided by the user (No), the process proceeds to step S112, where the evaluation result is displayed on an output unit such as a display to present it to the user, then the process will end and return control to the previous process.

On the other hand, if it is determined at step S104 that the evaluation result does not meet the order condition (No), the process proceeds to step S112.

Operation of the present invention will be described below.

The user can use the layout section 210 to perform layout tasks. In performing layout tasks, the user uses user operation input section (not shown) such as a keyboard and mouse to input layout operations, as in the first embodiment described earlier.

When user operations are inputted, the layout section 210 performs layout according to the user operations and generates an operation log information. The operation log information is registered in an operation log information storage DB.

The user can use the layout finishing section 120 to finish the layout. To make finishing adjustments to the layout, user requests the activation of the layout finishing section 120.

When the activation of the layout finishing section 120 is requested, the layout section 210 provides the layout result to the layout finishing section 120 along with the activation request.

When the layout finishing section 120 is activated in response to the activation request, the layout finishing section 120 makes adjustments to the layout result provided by the layout section 210 by adjusting the layout, color, and text representation and also making adjustments to an image, photograph or illustration.

The user can use the layout evaluating section 230 to obtain the evaluation of the layout. To obtain the evaluation of the layout, the user request the activation of the layout evaluating section 230.

When the activation of the layout evaluating section 230 is requested, the layout section 210 provides the layout result to the layout evaluation section 230 along with the activation request. When the layout evaluating section 230 is activated in response to the activation request, it performs steps S102 and S104 to evaluate given evaluation items of the layout result provided by the layout section 210 and compare the result of the evaluation with any of a number of order condition to determine whether or not the evaluation results meets the order condition. If the evaluation result meets the order condition, step S106 is performed to make determination as to whether or not the order condition requires user confirmation. If it is determined that user confirmation is required, step S110 is performed to prompt the user to confirm the order. If the user, on receiving the confirmation request, confirms the order, step S108 is performed and the layout result provided by the layout section 210 is outputted to the layout order placing section 140 along with an activation request.

When the layout order placing section 140 is activated in response to the activation request, the layout order placing section 140 generates layout data including the layout result from the layout section 210 and the operation log information in the operation log information storage DB and sends the layout data to a vender along with an order request.

If the user rejects order confirmation when prompted to confirm the order, or the evaluation result does not meet the order condition, the process proceeds to step S112 and the evaluation result is presented to the user.

If the evaluation result meets the order condition and user confirmation is not required, the process proceeds to step S108, where the layout result provided by the layout section 210 is provided to the layout order placing section 140 along with an activation request.

As described above, the layout system 200 according to the embodiment include the layout section 210 for performing layout according to operations performed by a user, layout evaluating section 230 for evaluating given evaluation items of a layout result provided by the layout section 210, and the layout order placing section 140 for placing an order for layout on the basis of the layout result provided by the layout section 210. The layout evaluating section 230 requests the layout order placing section 140 to place an order for layout, depending on the evaluation result.

Thus, the user can generate a layout through the use of the layout section 210 and, in addition, place an order for layout through the use of the layout order placing section 140. The user therefore can perform the process from the generation of the layout to the ordering of the layout as one continuous operation. Consequently, the embodiment can improve the efficiency of layout tasks compared with conventional technologies. Furthermore, the user can perform layout tasks with reference to evaluation results and therefore can provide a higher quality layout. Moreover, because an order for layout can be placed based on the evaluation result, a higher quality layout result can be provided to a vendor.

The layout evaluating section 230 according to the present invention evaluate a layout result provided by the layout section 210 and, if the result of the evaluation meets an order condition, requests the layout order placing section 140 to place an order for the layout.

Thus, a layout result with a quality that meets an order condition set by the user can be provided to a vendor.

Furthermore, the layout evaluating section 230 according to the present embodiment presents an evaluation result to the user and, if it receives confirmation from the user, requests the layout order placing section 140 to place an order for layout.

In this way, the user can see the evaluation result before an order of layout is placed. Therefore, the possibility that an order that is not desired by the user is placed can be reduced.

A third embodiment of the present invention will be described below with reference to the drawings.

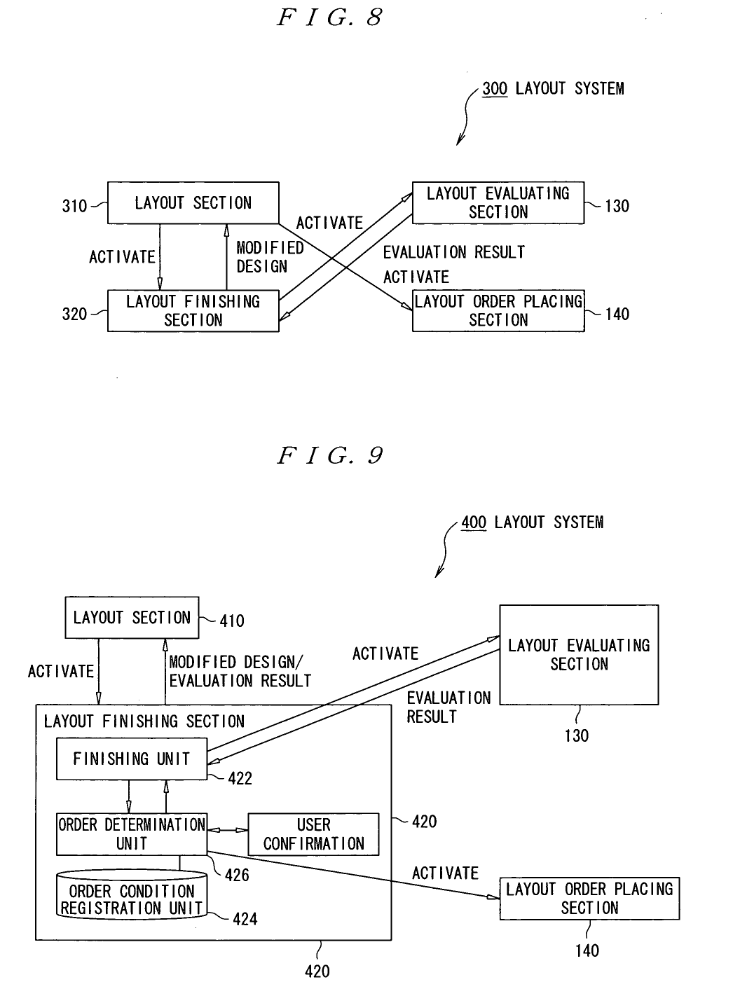

FIG. 8 shows a layout system with order-placement capability, a layout program with order-placement capability, and a layout method according toga third embodiment of the present invention.

In the third embodiment, a layout system with order-placement capability and a layout program with order-placement capability, and a layout method according to the present invention are applied to a case where a layout is designed and then an order for layout is placed. The third embodiment differs from the first embodiment in that layout evaluating section 230 activates layout evaluating section 130, as shown in FIG. 8. In the following description, only different elements of the third embodiments from the first embodiment will be described. The same elements of the third embodiment as those in the first embodiment are labeled with the same reference numerals and therefore the description thereof will be omitted.

A configuration of a layout system according to the present embodiment will be described below with reference to FIG. 8.

FIG. 8 is a block diagram showing a configuration of layout system 300 according to the third embodiment.

As shown in FIG. 8, the layout system 300 comprises layout section 310 for performing layout, layout finishing section 320 for making finishing adjustments to a layout result provided by the layout section 310, layout evaluating section 130 for evaluating the layout result provided from the layout section 310, and layout order placing section 140 for placing an order, depending on the layout result provided by the layout section 310.

The layout section 310 has substantially the same functions as those the layout section 110 described above. The layout section 310 differs from the layout section 110 in that it does not directly activate the layout evaluating section 130.

The layout finishing section 320 have substantially the same functions as those of the layout finishing section 120. The layout finishing section 320 differs from the layout finishing section 120 in that it activates the layout evaluating section 130.

Operation of the third embodiment will be described below.

A user can use the layout section 310 to perform layout tasks. To perform layout tasks, the user inputs layout operations thorough the use of user operation input section (not shown) such as a keyboard and a mouse as in the embodiments described earlier.

When user operations are inputted, the layout section 310 performs layout according to the user operations and generates an operation log information. The operation log information is stored in an operation log information storage DB.

The user can use the layout finishing section 320 to make finishing adjustments to a layout. Before performing finishing adjustments to the layout, the user request the activation of the layout finishing section 320.

When the activation of the layout finishing section 320 is requested, the layout section 310 provides the layout result to the layout finishing section 320 along with the activation request. When the layout finishing section 320 is activated in response to the activation request, the layout finishing section 320 makes adjustments to the layout result provided from the layout section 310 by adjusting the layout, color, and text representation and also making adjustments to an image, photograph or illustration. The layout result is outputted to the layout evaluating section 130 along with an activation request.

When the layout evaluating section 130 is activated in response to the activation request, the layout evaluating section 130 evaluates given evaluation items of the layout result provided by the layout section 310 and the result of the evaluation is presented to the user.

The user can use the layout order placing section 140 to place an order for layout. When placing the order, the user request the activation of the layout order placing section 140.

When the activation of the layout order placing section 140 is requested, the layout section 310 provides the layout result to the layout order placing section 140 along with the activation request. When the layout order placing section 140 is activated in response to the activation request, the layout order placing section 140 generates layout data including the layout result provided by the layout section 310 and the operation log information in the operation log information storage DB and sends the layout data to a vendor along with an order request.

According to the third embodiment, the layout system 300 includes the layout section 310 for performing layout according to user operations, the layout finishing section 320 for making finishing adjustments to a layout according to a layout result provided by the layout section 310, the layout evaluating section 130 for evaluating the layout result provided by the layout section 310, and the layout order placing section 140 for placing an order for layout, depending on the layout result provided by the layout section 310, as described above, wherein the layout finishing section 320 activates the layout evaluation section 130.

Thus, the user can produce a layout through the use of the layout section 310 and also can place an order for layout through the use of the layout order placing section 140.

The user therefore can perform the process from the generation of the layout to the ordering of the layout as one continuous operation. Consequently, the embodiment can improve the efficiency of layout tasks compared with conventional technologies. Furthermore, the user can perform layout tasks with reference to evaluation results and therefore can provide a higher quality layout.

A fourth embodiment of the present invention will be described below with reference to the drawings.

FIGS. 9 to 11 shows a layout system with order-placement capability, a layout program with order-placement capability, and a layout method according to the fourth embodiment of the present invention.

In the fourth embodiment, a layout system with order-placement capability and a layout program with order-placement capability, and a layout method according to the present invention are applied to a case where a layout is designed and then an order for layout is placed. The fourth embodiment differs from the first embodiment in that layout finishing section 420 activates layout order placing section 140, as shown in FIG. 9. In the following description, only different elements of the fourth embodiments from the first embodiment will be described. The same elements of the fourth embodiment as those in the first embodiment are labeled with the same reference numerals and the description thereof will be omitted.

A configuration of a layout system according to the fourth embodiment will be described first with reference to FIG. 9.

FIG. 9 is a block diagram showing a configuration of a layout system 400 according to the fourth embodiment.

As shown in FIG. 9, the layout system 400 comprises layout section 410 for performing layout tasks, layout finishing section 420 for making finishing adjustments to a layout according to the layout result provided by the layout section 410, a layout evaluating section 130 for evaluating the layout result provided by the layout section 410, and layout order placing section 140 for placing an order for layout, depending on the layout result provided from the layout section 410.

The layout section 410 have substantially the same functions as those of the layout section 110 and differs from the layout section 110 in that it does not directly activates the layout evaluating section 130 and the layout order placing section 140.

As shown in FIG. 9, the layout finishing section 420 includes a finishing unit 422 for modifying a layout result provided by the layout section 410, an order condition registration unit 424 in which acceptance criteria and order conditions are registered, and order determination unit 426 for determining on the basis of the result of modification by the finishing unit 422 and order conditions in the order condition registration unit 424 whether or not an order for layout should be placed.

The finishing unit 422 is activated in response to an activation request from the layout section 410 and modifies a layout result provided by the layout section 410.

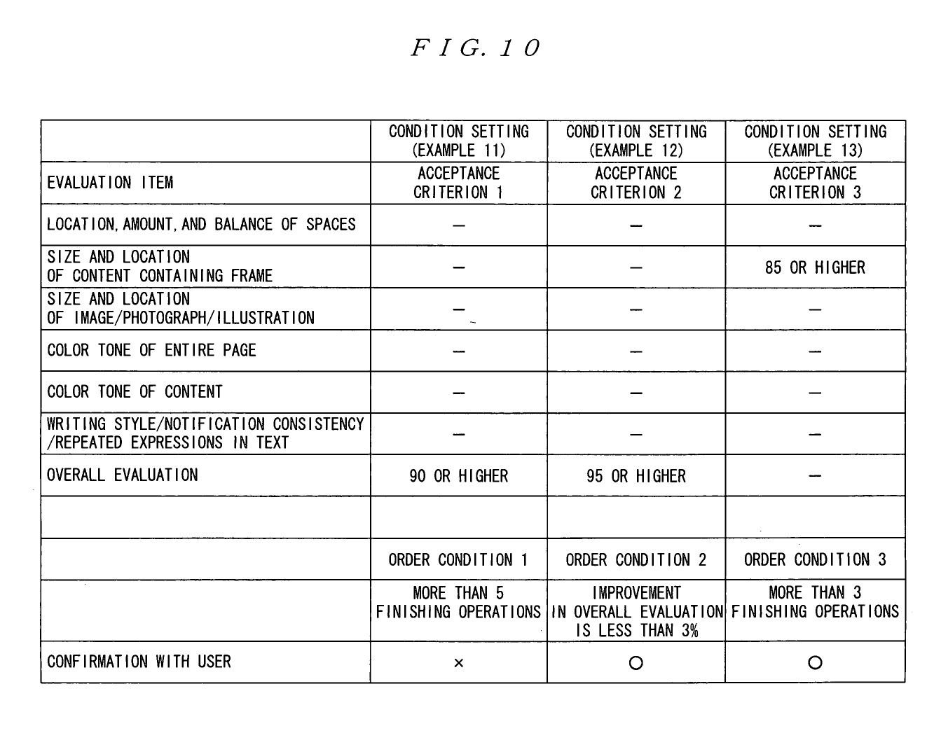

FIG. 10 shows a structure of data registered in the order condition registration unit 424.

As shown in FIG. 10, registered in the order condition registration unit 424 are acceptance criteria for determining whether the quality of a layout satisfies predetermined criteria and order conditions for determining whether or not an order for layout should be placed.

In example 11 in FIG. 10, acceptance criterion 1 specifies that the overall evaluation of a layout result should be 90 or higher and order condition 1 specifies that the number of times the layout has been modified by the finishing unit 422 (herein after simply referred to as “finishing operations”) should be 5 or more, and user confirmation is not required for placing an order for layout. First, as finishing operations, five adjustments are made to each evaluation item until the overall evaluation value reaches 90 or higher. If the layout is not accepted after the five finishing operations, an order for layout is placed by the layout order placing section 140 (hereinafter simply referred to as “ordering process”) because the order condition is met. If the acceptance criterion is reached before five finishing operations are performed, then the layout result and evaluation result are returned to the layout section 410.

In example 12 in FIG. 10, acceptance criterion 2 specifies that the overall evaluation of a layout result is 95 or higher and order condition 2 specifies that improvement in the overall evaluation is 3% or less and user confirmation is required for placing an order for layout. First, finishing operations are performed until the overall evaluation reaches 95 or higher. If improvement in the overall evaluation after completion of finishing operation is less than 3%, then an ordering process is initiated. Because user confirmation is required, the user is prompted to confirm the order. If the order is confirmed, an ordering process is performed. If improvement is 3% or more, it is determined that the layout has substantially been improved. If improvement after finishing operations is less than 3%, it is determined that the layout can hardly be brought to perfection in an automatic manner, therefore an ordering process is performed. The user may want to choose not to place an order. The user can make modification to an automatically adjusted layout by him/herself or reactivate the layout finishing section 420, and then place an order if necessary.

In example 13 in FIG. 10, acceptance criterion 3 specifies that the evaluation of the size and location of content containing frames should be 85 or higher and order condition 3 specifies that the number of times of modifications performed by the finishing unit 422 is three or more and user confirmation is required. First, finishing operations are performed until the evaluation of the size and location of contents region becomes 85 or higher. In this example, the acceptance criteria is set only for the size and location of content regions. Therefore only the design points that may improve this item is adjusted. If the layout is not accepted after-three finishing operations, then the order condition is met and an ordering process is initiated after user confirmation or layout tasks are performed again in the layout section 410.

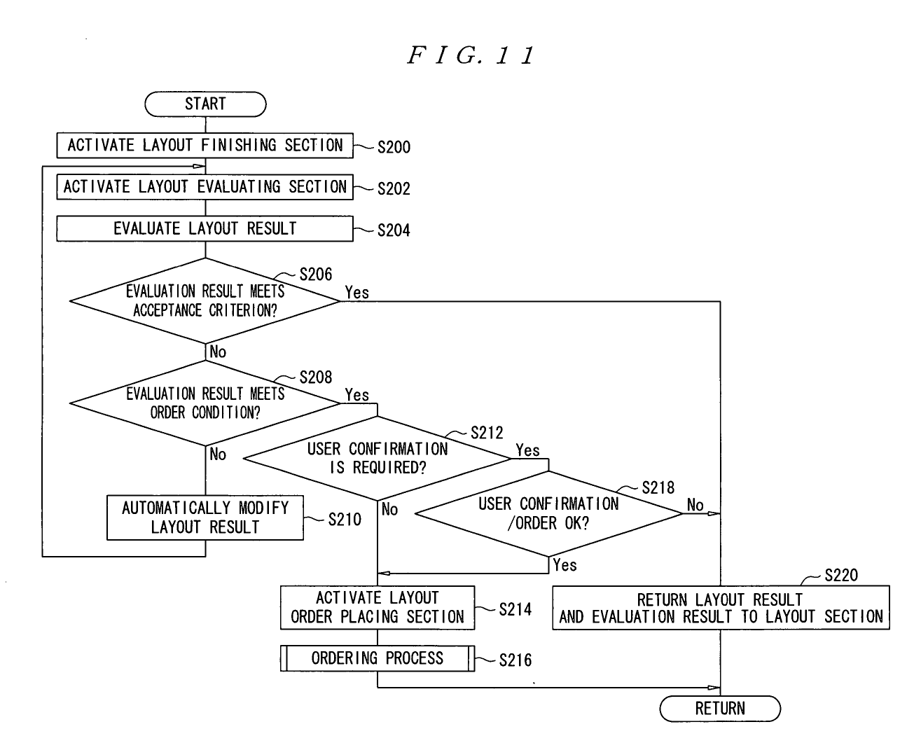

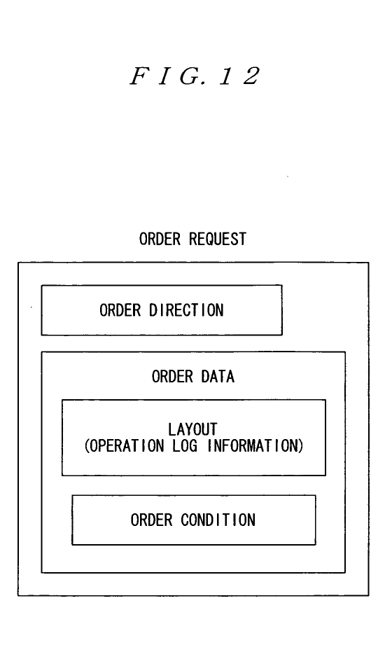

In practice, the layout finishing section 420, layout evaluating section 130, and layout order placing section 140 have the same capabilities as those of a typical computer in which a CPU, ROM, RAM, and interface are interconnected through a bus. The CPU activates a predetermined program stored in a predetermined area in the ROM and executes a layout finishing process shown in the flowchart in FIG. 11 according to the program.

FIG. 11 is the flow chart of the layout finishing process.

When the layout finishing process is initiated in the CPU, the process first proceeds to step S200 as shown in FIG. 11.

At step S200, the layout finishing section 420 is activated, then the process proceeds to step S202, where the layout evaluating section 130 is activated. Then the process proceeds to step S204, where given evaluation items of a layout result provided by the layout section 410 are evaluated. The process then proceeds to step S206. In particular, at step S204, the following items are evaluated for example: (1) the location, amount, or balance of spaces; (2) the size or location of content containing frames; (3) the size or location of images, photographs, or illustrations in a content containing frame; (4) the color tone of an entire page; (5) the color tone of a content containing frame; and (6) the consistency of writing style and notation and repetition of the same expressions in text are evaluated based on a scale of 100. Alternatively, the weighted average of these items may be calculated and normalized for a maximum of 100 to obtain an overall evaluation.

At step S206, the evaluation result is compared with any of a plurality of acceptance criteria to determine whether the evaluation result meets the acceptance criterion. If it is determined that the evaluation result does not meet the evaluation criterion (No), the process proceeds to step S208, where the evaluation item is compared with any of a plurality of order conditions to determine whether the evaluation result meets the order condition. If it is determined that the evaluation result does not meet the order condition (No), the process proceeds to step S210, where the layout result provided by the layout section 410 is automatically modified and then the process proceeds to step S202.

On the other hand, if it is determined at step S208 that the evaluation result meets the order condition (Yes), the process proceeds to step S212, where determination is made as to whether the order condition specifies that user confirmation is required. If it is determined that the order condition does not specify that user confirmation is required (No), the process proceeds to step S214.

At step S214, the layout result from the layout section 410 is provided to the layout order placing section 140 along with an activation request. The process then proceeds to step S216, where an ordering process is performed. Then the process will end and returns control to the previous process.

On the other hand, if it is determined at step S212 that the order condition specifies that user confirmation is required (Yes), the process proceeds to step S218, where a user is prompted to confirm the order and then determination is made as to whether confirmation has been provided by the user. If it is determined that confirmation has been provided by the user (Yes), the process proceeds to step S214.

On the other hand, if it is determined at step S218 that confirmation has not been provided by the user (No), the process proceeds to step S220, where the layout result is returned to the layout section 410 together with the evaluation result, then the process will end and return control to the previous process.

On the other hand, if it is determined at step S206 that the evaluation result meets the acceptance criterion (Yes), the process proceeds to step S220.

Operation of the present embodiment will be described below.

A user can use the layout section 410 to perform layout tasks. When performing layout tasks, the user uses user operation input section (not shown) such as a keyboard and mouse to input layout operations, as in the embodiments described earlier.

When user operations are inputted, the layout section 410 performs layout according to the user operations and generates an operation log information. The operation log information is stored in an operation log information storage DB.

The user also can use the layout finishing section 420 to make finishing adjustments to a layout. Before performing finishing adjustments, the user requests the activation of the layout finishing section 420.

When the activation of the layout finishing section 420 is requested, the layout section 410 provides a layout result to the layout finishing section 420 along with the activation request. When the layout finishing section 420 is activated in response to the activation request, steps S202 and S204 are performed. The layout finishing section 420 activates the layout evaluating section 130, which evaluates given evaluation items of the layout result from the layout section 410.

Then step S206 is performed and the layout finishing section 420 compares the evaluation result with any of a plurality of acceptance criteria to determine whether evaluation result meets the acceptance criterion. If the evaluating result does not meet the acceptance criterion, step S208 is performed, where the evaluation result is compared with any of order conditions to determine whether the evaluation result meets an order condition. If the evaluation result meets the order condition, step S212 is performed, where determination is made as to whether order condition specifies that user confirmation is required. If it is determined that user confirmation is required, step S218 is performed, where a user is prompted to confirm an order. When the user confirms the order in response to the prompt, step S214 is performed, where the layout result provided from the layout section 410 is provided to the layout order placing section 140 along with an activation request.

When the layout order placing section 140 is activated in response to the activation request, step S216 is performed, where the layout order placing section 140 generates layout data including the layout result provided by the layout section 410 and an operation log information from the operation log information storage DB and sends to the layout data to a vendor together with an order request.

On the other hand, if the user rejects the order when the user is prompted to confirm the order, or the evaluation result meets the acceptance criterion, step S220 is performed and the layout result provided by the layout section 410 is returned to the layout section 410 along with the evaluation result.

If the evaluation result meets the order condition and user confirmation is not required, step S214 is performed, where the layout result provided by the layout section 410 is provided to the layout order placing section 140 along with an activation request.

If the evaluation result meets neither of the acceptance criterion and order condition, step S210 is performed, where the layout result provided by the layout section 410 is automatically modified.

As described above, the layout system 400 in the present embodiment comprises the layout section 410 for performing layout according to user operations, the layout finishing section 420 for making finishing adjustments to a layout based on a layout result provided by the layout section 410, the layout evaluating section 130 for evaluating given evaluation items of the layout result provided by the layout section 410, the layout order placing section 140 for placing an order for layout, depending on the layout result provided by the layout section 410, wherein the layout finishing section 420 requests the layout order placing section 140 to place the order for layout, depending on the evaluation result.

Thus, the user can produce a layout through the use of the layout section 410 and also can place an order for layout through the use of the layout order placing section 140. The user therefore can perform the process from the generation of the layout to the ordering of the layout as one continuous operation. Consequently, the embodiment can improve the efficiency of layout tasks compared with conventional technologies. Furthermore, the user can perform layout tasks with reference to evaluation results and therefore can provide a higher quality layout. Moreover, because an order for layout can be placed based on the evaluation result, a higher quality layout result can be provided to a vendor.

Furthermore, the layout finishing section 420 in the present embodiment evaluates a layout result provided by the layout section 410 and, if the result of evaluation of the layout result does not meet an acceptance criteria and meets an order criterion, requests the layout order placing section 140 to place an order for layout.

Consequently, a layout result of quality in accordance with the acceptance criterion and order condition set by a user can be provided to a vendor.

In addition, the layout finishing section 420 in the present embodiment presents an evaluation result to the user and, if it receives confirmation from the user, requests the layout order placing section 140 to place an order for layout.

In this way, the user can see the evaluation result before an order of layout is placed. Therefore, the possibility that an order that is not desired by the user is placed can be reduced.

The layout order placing section 140 in the first to fourth embodiments places order for layout, depending on a layout result. More particularly, the layout order placing section 140 may use one of a plurality of ordering scheme that is specified by a user to place an order for layout, depending on the layout result.

This can improve the usability of the system because an order for layout can be placed by using a user-specified ordering scheme.

Hardware that embodies each of the layout section 110, 210, 310, 410, layout finishing section 120, 320, 420, and user operation input section 111 in the first to fourth embodiment may be an information processing apparatus such as a personal computer. User confirmation in the order determination sections 236 and 426 of the layout evaluating section 230 and layout finishing section 420, respectively, may be performed by using a cellphone.

Hardware that embodies the layout order placing section 140 and the layout evaluating section 130, 230 maybe a scanner (including combined scanner printer, a copying machine, and a facsimile machine) as well as an information processing apparatus such as a personal computer.

The layout section 110, 210, 310, 410, layout finishing section 120, 320, 420, the user operation input section 111, and the layout order placing section 140 can be classified as a client and the layout evaluating section 230 and the layout finishing section 420 can be classified as a server in functional terms.

While the processes shown in FIGS. 7 and 11 in the second to fourth embodiments have been described with respect to a case where a control program stored in a ROM is executed, the present invention is not so limited. A program indicating the procedures stored in a storage medium may be read into a RAM and executed.

The storage medium may be any storage medium, including a semiconductor storage medium such as a RAM and a ROM, a magnetic storage medium such as an FD and an HD, an optical storage medium such as a CD, CDV, LD, and DVD, or a magnetically-store/optically-read storage medium such as an MO, that can be read by a computer, regardless of whether it can be read electronically, magnetically, or optically. Alternatively, the program may be downloaded over a network.

While in the first to fourth embodiments, the layout system with order-placement capability, a layout program with order-placement capability, and a layout method according to the present invention are applied to a case where an order for layout is placed after performing layout, they can be applied to any other cases without departing from the scope and spirit of the present invention.

1. A layout system with order-placement capability for performing layout, comprising:
layout section for performing layout; and
layout order placing section for placing an order for layout on the basis of a layout result produced by said layout section.

2. The layout system with order-placement capability according to claim 1, further comprising user operation input section for inputting user operations, wherein said layout section performs layout according to operations inputted through said user operation input section.

3. The layout system with order-placement capability according to claim 2, wherein:
said layout order placing section for generating order data including a layout result produced by said layout section and sending said generated order data to a vendor together with an order request.

4. The layout system with order-placement capability according to claim 2, wherein:
said layout order placing section generates order data including an operation log information from which operations inputted through said user operation input section can be retraced and a layout result produced by said layout section and sending said data to a vendor together with an order request.

5. The layout system with order-placement capability according to claim 2, wherein:
said layout order placing section generates order data including an operation log information indicating the log of operations inputted through said user operation input section and the layout result produced by said layout section and sending said generated order data to a vendor together with an order request.

6. The layout system with order-placement capability according to any claim 1, wherein said layout system is communicably connected to a matching system that performs matching with a designer, and said layout order placing section generates order data including a layout result produced by said layout section and sends said generated order data to said matching system together with an order request.

7. The layout system with order-placement capability according to claim 1, wherein said layout system is communicably connected to a matching system for matching an order request with a designer, and said layout order placing section generates order data including a layout result produced by said layout section and sends said generated order data to said matching system together with an order request.

8. The layout system with order-placement capability according to claim 1, further comprising layout evaluating section for evaluating a layout result produced by said layout section.

9. The layout system with order-placement capability according to claim 8, wherein:
said layout evaluating section evaluates a layout result produced by said layout section and, depending on the result of the evaluation, requests said layout order placing section to place an order for layout; and
said layout order placing section places an order for layout on the basis of a layout result produced by said layout section if said layout order placing section is requested to place an order for layout.

10. The layout system with order-placement capability according to claim 8, wherein an order condition can be set in said layout system and said layout evaluating section evaluate a layout result produced by said layout section and, if the result of the evaluation meets said order condition, requests said layout order placing section to place an order for layout.

11. The layout system with order-placement capability according to claim 8, wherein said layout evaluating section presents said evaluation result to a user and, if placement of an order for layout is approved by said user, requests said layout order placing section to place said order for layout.

12. The layout system with order-placement capability according to claim 1, wherein:
said layout order placing section places an order for layout on the basis of a layout result produced by said layout section by using one of a plurality of ordering system that is specified by the user.

13. A layout program with order-placement capability for performing layout that causes a computer to perform processing implemented as layout section for performing layout and layout order placing section for placing an order for layout depending on a layout result produced by said layout section.

14. A layout method for performing layout, comprising the steps of:
performing layout; and
placing an order for layout depending on a layout result produced in said step of performing layout.
